(19) United States
(12) Patent Application Publication
(10) Pub. No.: US 2024/0359155 A1
(43) Pub. Date: Oct. 31, 2024

(54) CONTINUOUS PRODUCTION SYSTEMS FOR THERMOCHEMICAL REACTIONS

(71) Applicant: Sierra Space Corporation, Broomfield, CO (US)

(72) Inventors: Rick Burkholder, Broomfield, CO (US); Nathan Haggerty, Broomfield, CO (US)

(21) Appl. No.: 18/644,948

(22) Filed: Apr. 24, 2024

Related U.S. Application Data
(60) Provisional application No. 63/499,077, filed on Apr. 28, 2023.

(51) Int. Cl. B01J 19/12; B01J 19/00; B01J 37/34

(52) U.S. Cl. CPC B01J 19/121; B01J 19/0053; B01J 37/349

(57) ABSTRACT

Methods, devices, and systems are described for a system including a concentrated light source configured to focus light energy along a line of focus and a moving platform configured to face the concentrated light source and suspend a reactants mixture. The system also includes a controller coupled to the concentrated light source and the moving platform. The controller is configured to drive the moving platform at a first speed and a second speed. Suspending the reactants mixture within the line of focus of the concentrated light source as the moving platform is driven at the first speed converts the reactants mixture to slag. Suspending the reactants mixture as the moving platform is driven at the second speed does not convert the reactants mixture to slag.

### CROSS-REFERENCE TO RELATED APPLICATIONS

This application claims priority to U.S. Provisional Application No. 63/499,077 entitled “CONTINUOUS PRODUCTION SYSTEMS FOR THERMOCHEMICAL REACTIONS” and filed on Apr. 28, 2023, the disclosure of which is incorporated herein by reference in its entirety.

### TECHNICAL FIELD

The present disclosure relates generally to metallurgy, and more particularly, to systems and techniques for producing continuous batching of carbothermal reductions to reduce metal oxides.

### BACKGROUND

Advances in space exploration have identified a great need for efficient extraterrestrial metal processing to expand human exploration and construction capabilities. Processing extraterrestrial metals substantially reduces the costs and risks of bringing supplies from Earth while allowing for efficient use of resources to enable endeavors in space exploration. Extraterrestrial surfaces are covered by a granular material known as regolith that includes extraterrestrial metals. Regolith may be deoxidized to obtain oxygen. If oxygen is extracted, the regolith could be used to facilitate construction. Effectively processing regolith supports a permanent human presence on the moon and other planets.

Processing regolith has been adapted for use in spaceflight to produce oxygen. Metallic oxides in the regolith are mixed with a carbon source to produce carbon monoxide under heat. The carbon monoxide is then chemically converted to oxygen in a downstream process. The reaction requires a heat source to heat the regolith to >1600 C to produce the thermochemical reaction necessary to extract the carbon monoxide for conversion to oxygen. But this manufacturing process is costly and inefficient, especially when producing large quantities of carbon monoxide for conversion to oxygen. Efficient methods and systems are needed to increase the production rates of carbon monoxide for conversion to oxygen.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 depicts an example of a carbothermal reduction system configured to reduce metallic oxides from regolith using a concentrated light source;

FIG. 2 depicts an aerial view of an example of a concentrated light source having three optical inlets positioned over a moving platform configured to support processing of reactants mixtures;

FIG. 3 depicts an example of a block diagram illustrating a controller communicatively coupled to a concentrated light source, a moving platform, and a scooper for controlling the uninterrupted reduction of metallic oxides from regolith;

FIG. 4 depicts an example of a moving platform configured to be driven to a plurality of stations of the carbothermal reduction system, the plurality of stations configured to perform processing steps for carbothermal reduction;

FIG. 5 depicts an example of a flowchart of a method configured to drive the moving platform at a first speed and a second speed to create discontinuities in the solidified slag;

FIG. 6A depicts an example of a flowchart of a method configured to drive the moving platform at a first speed and a second speed based on whether the reactants mixture is situated within the line of focus of the concentrated light source;

FIG. 6B depicts an example of a flowchart of a method configured to drive the moving platform at a first speed and a second speed based on whether a batch of reactants mixture is situated at a first station of the plurality of stations or situated between the first and a second station of the plurality of stations;

FIG. 7 depicts an example of a moving platform divided into a plurality of sections where the sections are configured to suspend a batch of reactants mixture that is in the same melt stage;

FIG. 8 depicts an example of a moving platform divided into a plurality of sections, the sections configured to suspend two or more batches of reactants mixture in which the two or more batches of reactants mixtures are in different melt stages;

FIG. 9 depicts an example of a moving platform divided into a plurality of sections, the sections configured to suspend two or more batches of reactants mixture in which the two or more batches of reactants mixture form an alternating pattern of reactants mixtures having a different melt stage or melt processing time;

FIG. 10 depicts an example of a moving platform divided into sections in which each section of the plurality of sections has a trough for suspending one or more batches;

FIG. 11 depicts an example of a recessed moving platform;

FIG. 12 depicts an example of a scooper having a plurality of blades arranged in a frame, the plurality of blades being configured to collect slag suspended on the moving platform and to prevent the slag from passing to the other stations of the carbothermal reduction system;

FIG. 13 depicts an example of a chute connected to the grating, the chute having a narrow end furthest from the grating, the chute configured to be vibrated to allow any reactants mixture gathered by the scooper to vibrate down to the narrow end furthest from the grating to be deposited onto the moving platform for reprocessing; and

FIG. 14 depicts a block diagram illustrating a computing system consistent with implementations of the current subject matter.

### DETAILED DESCRIPTION

The methods, systems, and apparatuses described herein are for producing continuous batching of carbothermal reductions to deoxidize metal oxides. In the following detailed description, reference is made to the accompanying drawings, which form a part hereof. In the drawings, similar symbols generally identify similar components, unless context dictates otherwise. The illustrative alternatives described in the detailed description, drawings, and claims are not meant to be limiting. Other alternatives may be used and other changes may be made without departing from the spirit or scope of the subject matter presented here. It will be readily understood that the aspects, as generally described herein, and illustrated in the Figures, can be arranged, substituted, combined, and designed in a wide variety of different configurations, all of which are explicitly contemplated and make part of this application.

The uninterrupted production systems described herein are configured to provide a non-stop production to maximize output. For example, continuously performing carbothermal reduction on several batches of metal oxides found in regolith may maximize carbon monoxide output. Carbothermal reduction systems are a type of technology used to convert metal oxides into metals through the application of heat and a carbon source. The reduction process releases carbon monoxide that may be later converted into oxygen. Unlike conventional systems, the carbothermal reduction systems described herein are efficient and well-suited for mass-producing carbon monoxide and, subsequently, oxygen by using a moving platform positioned underneath a concentrated light source. A moving platform can continuously process batches without interruption so that the downtime of the system is minimal for removing slag and recovering carbon. For example, the moving platform can be intermittently driven at a faster speed than normal to move the reactants mixture from underneath the concentrated light source and prevent the slag from being solidified into one continuous piece.

The moving platform may be configured to cycle repeatedly through a plurality of stations of the carbothermal reduction system. Each station of the plurality of stations may be configured to perform a processing step related to carbothermal reduction. For example, a section of the moving platform may arrive at a heating station in which the material at the section of the moving platform is heated to the temperatures required for the carbothermal reduction reaction to take place. In another example, a section of the moving platform may arrive at a slag removal station in which slag is removed from the section of the moving platform of the carbothermal reduction system. In yet another example, a section on the moving platform may arrive at a regolith station of the carbothermal reduction system. The plurality of stations enables the simultaneous processing of a reactants mixture. The reactants mixture may be a reactant or a plurality of reactants.

On the moving platform, the reactants mixture may pass through a lifecycle starting with freshly mixed regolith to molten regolith and, lastly, slag. One section of the moving platform may carry the same reactants mixture through its lifetime from freshly mixed regolith to slag. Once the reactants mixture becomes slag, the carbothermal reduction system removes the slag to maintain maximum deoxidation rates of the reactants mixture. In some embodiments, the reactants mixture is added near the beginning station of the plurality of stations. The same reactants mixture may be heated at one or more stations of the carbothermal reduction system. Near the end of the plurality of stations, the reactants mixture may expire into slag that requires removal from the platform. The slag removal station may remove the slag before the moving platform is driven to the next station or the beginning of the cycle in which freshly mixed reactants mixture is added.

The moving platform may be divided into a plurality of sections where each section may be configured to suspend a batch of reactants mixture. For example, the moving platform may be divided into pie-shaped sections for a rotating disc platform or rectangular portions for a conveyor belt platform. Each section of the moving platform may be driven to each of the plurality of stations. The sections holding batches may be continually introducing unprocessed reactants mixture to the stations of the carbothermal reduction system. In other words, processed regolith may leave a station and new incoming unprocessed regolith may arrive at a station. The plurality of sections enables simultaneous processing of a reactants mixture. In some embodiments, the reactants mixture may be a mixture including regolith to generate carbon monoxide and oxygen.

The carbothermal reduction system includes a concentrated light source for creating the thermochemical reactions and carbothermal reductions. The concentrated light source may be positioned over the moving platform. The concentrated light source may include laser energy sources and may be positioned at varying locations to allow simultaneous processing of a reactants mixture. The concentrated light sources may be distributed above and across the moving platform to allow heating to be performed at different stations. For example, the concentrated light sources may correspond to stations on the rotating platform where a batch of the reactants mixture may be heated. In another example, the concentrated light sources may move to sections of the moving platform to perform heating on a batch of reactants mixture.

The speeds at which the reactants mixture passes through the heating locations and the various stages may maximize system output. For example, the reactants mixture may be a mixture including regolith and adjusting the speeds at which the regolith mixture passes through the heating locations may maximize the amount of carbon monoxide output from the carbothermal reduction system. A controller may be communicatively coupled to the moving platform, the concentrated light source, and a scooper to control the rate of carbothermal reduction processing. The controller may be configured to control the speed at which the moving platform traverses each of the stations of the carbothermal reduction system. For example, the controller may drive the moving platform at a first speed, the moving platform configured to suspend the reactants mixture within the line of focus of the concentrated light source as the moving platform is driven at the first speed. Suspending the reactants mixture within the line of focus of the concentrated light source as the moving platform is driven at the first speed converts the reactants mixture to slag. In another example, the controller may drive the moving platform at the first speed in response to the batch being situated at a first station of the plurality of stations. The controller may be configured to determine whether the concentrated light source applies heat to the moving platform. The controller may be configured to operate the scooper to remove slag from the moving platform.

The continuous production system may be configured to optimize thermochemical reactions and, more specifically, carbothermal reduction. Embodiments described herein illustrate how the continuous production system can be a non-stop, uninterrupted system to maximize the output of the reactant processing time. For example, the continuous production system can maximize the deoxidation process of regolith to extract carbon monoxide and, subsequently, produce oxygen. The embodiments described herein have minimal downtime compared to conventional production systems performing carbothermal reduction. The minimal downtime of the continuous production system described herein may be achieved through a moving platform carrying batches of reactants mixture to various stations in a cyclical manner. The moving platform may be operated at different speeds, separating solidified slag into distinct chunks, which are easier to remove from the platform. Other embodiments for minimizing production downtime include having stations of the carbothermal system move across a platform carrying batches of reactants mixture until the batch of reactants mixture has undergone processing steps of each station of the carbothermal reduction system.

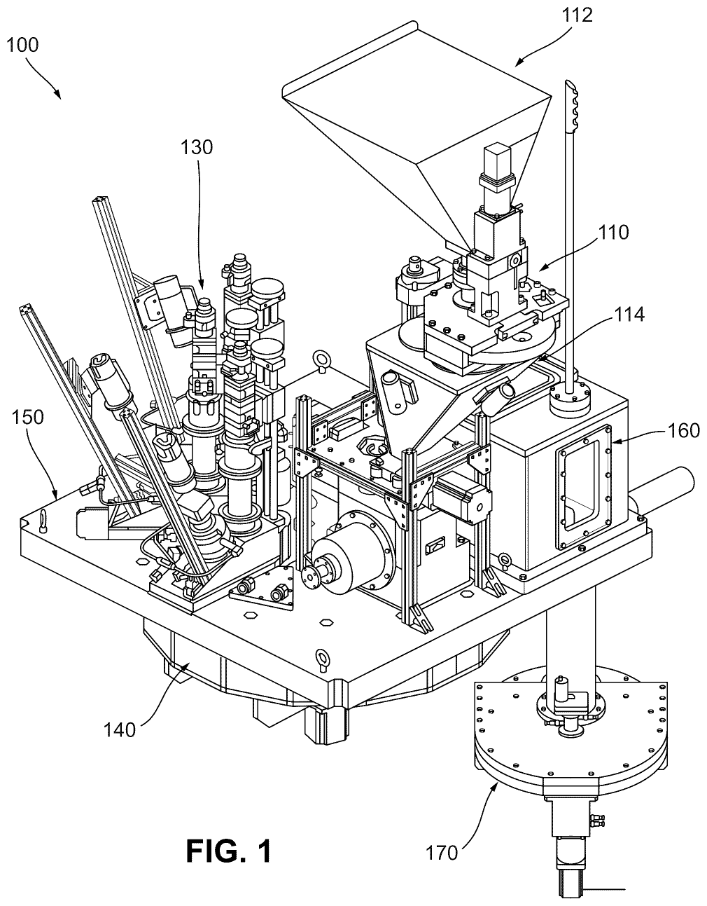

Referring to FIG. 1, illustrated is an example of a carbothermal reduction system 100 configured to reduce metallic oxides from regolith using a concentrated light source 130. The carbothermal reduction system 100 includes an inlet valve assembly 110, a concentrated light source 130, a moving platform 140, a heat shield 150, a slag removal assembly 160, and an outlet valve assembly 170. Carbothermal reduction systems are a type of technology used to convert metal oxides into metals through the application of heat and a carbon source. The conversion process releases carbon monoxide that may be later converted to oxygen. Unlike conventional systems, the carbothermal reduction systems described herein are efficient and well-suited for mass-producing carbon monoxide and, subsequently, oxygen by using a moving platform 140 positioned underneath a concentrated light source 130.

At the inlet valve assembly 110, regolith can be received. The regolith can include oxidized metals. For example, oxidized metals can comprise more than 90% of lunar regolith by weight. The lunar regolith can be received at the inlet valve assembly 110. The inlet valve assembly 110 may be communicatively coupled to a controller. The controller can selectively actuate the inlet valve assembly 110 to control the flow of regolith into the carbothermal reduction system 100. The inlet valve assembly 110 may include a hopper 112 coupled to the intake side. The hopper 112 may have a top opening wider than the opening flowing to the inlet valve assembly 110. The hopper 112 may taper from the top side to the bottom side to make the regolith easier to load into the carbothermal reduction system 100 while simultaneously funneling the regolith to the inlet valve assembly 110. The inlet valve assembly 110 may be coupled to a first silo 114 beneath the inlet valve assembly 110. The inlet valve assembly 110 may be situated above a moving platform 140 of the carbothermal reduction system 100. The inlet valve assembly 110 may allow gravity to perform the work of moving regolith from the hopper 112 through the inlet valve assembly 110 to the first silo 114.

The concentrated light source 130 may be positioned above the moving platform 140 and configured to focus light energy along a line of focus toward the moving platform 140. The concentrated light source 130 may include a plurality of lasers or a plurality of concentrated solar light inlets. The plurality of lasers or concentrated solar light inlets may be configured to heat the reactants mixtures suspended on the moving platform 140. The concentrated solar light inlet may channel a solar light source. Each of the concentrated light sources 130 may be configured to focus light energy along a line of focus toward the moving platform 140. Each of the concentrated light sources 130 may be communicatively coupled to a controller configured to control the intensity of light within the line of focus directed toward the moving platform 140.

The moving platform 140 may be situated below the inlet valve assembly 110, and the concentrated light source 130. The moving platform 140 may be configured to face the concentrated light source 130 and configured to suspend a reactants mixture during movement of the moving platform 140. The moving platform 140 may be configured to cycle repeatedly through a plurality of stations of the carbothermal reduction system 100. Each station of the plurality of stations may be configured to perform processing steps related to carbothermal reduction. In some embodiments, the moving platform 140 may be divided into a plurality of sections where each section is configured to suspend a batch of reactants mixture. The concentrated light source 130 may be configured to heat the batch of reactants mixtures suspended by a section of the plurality of sections of the moving platform 140.

The slag removal assembly 160 may be configured to remove slag on the moving platform 140 created by the carbothermal reduction reaction from the concentrated light sources 130. The slag forms on the moving platform 140 after the deoxidation process of the reactants mixture is complete. Since excess slag interferes with the deoxidation of reactants mixture further added to the moving platform 140, the slag removal assembly 160 removes the excess slag before more reactants mixture is added to the moving platform 140.

The slag removal assembly 160 includes a scooper 262, a grating 264, and a chute 266. The scooper 262 is configured to prevent the slag from passing through the scooper 262. The scooper 262 may have a plurality of blades arranged in a frame where the plurality of blades is configured to allow the unprocessed reactants mixture to pass through the scooper 262. he plurality of blades may be situated sufficiently close to one another such that they are configured to collect slag suspended on the moving platform 140. The frame of the scooper 262 may be configured to rotate upwards to lift the slag off the moving platform 140 and to cause the slag to fall into a grating 264. In some embodiments, any unprocessed reactants mixture that was scooped may fall in the grating back onto the moving platform 140 for further deoxidation processing. The chute 266 may be connected to the grating 264 and has a narrow end furthest from the grating 264. The chute 266 may be configured to be vibrated to allow the reactants mixture gathered by the scooper 262 to vibrate down to the narrow end furthest from the grating 264 to be deposited onto the moving platform 140.

The carbothermal reduction system 100 further includes an outlet valve assembly 170 configured to control the flow of carbon monoxide extracted from the reactants mixture. The reactants mixture may be a reactant or a plurality of reactants. The reduction process releases carbon monoxide that may be later converted to oxygen. Metallic oxides in the regolith may produce carbon monoxide when heated. The carbon monoxide is then chemically converted to oxygen in a downstream process.

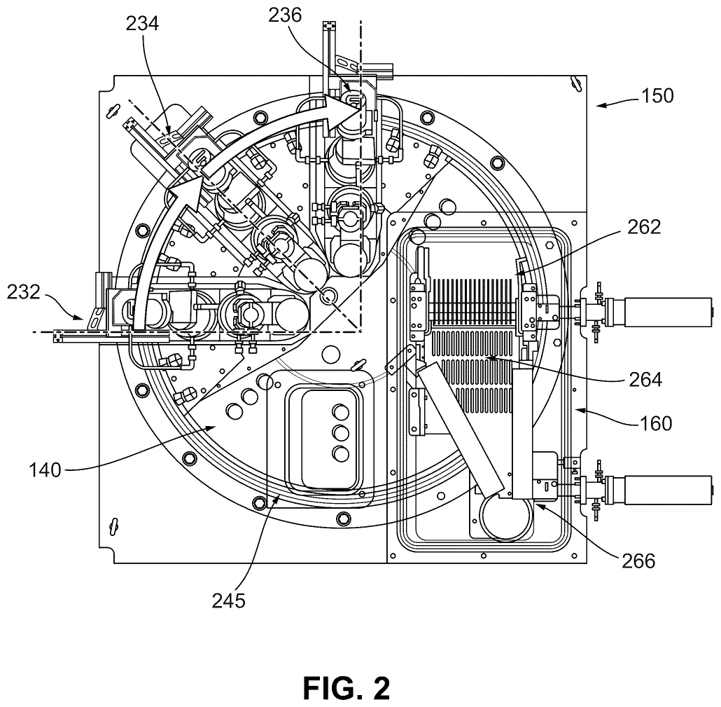

Referring to FIG. 2, illustrated is an aerial view of an example of a concentrated light source 130 having a first optical inlet 232, a second optical inlet 234, and a third optical inlet 236 positioned over a moving platform 140 configured to support a reactants mixture. The moving platform 140 may be positioned below the concentrated light source 130 (which includes the first optical inlet 232, the second optical inlet 234, and the third optical inlet 236) and the scooper 262. The concentrated light source 130 and the scooper 262 may be stations of the carbothermal reduction system 100. The moving platform 140 may be configured to move such that reactants mixture passes through each station of the carbothermal reduction system 100. The moving platform 140 may be configured to cycle repeatedly through a plurality of stations of the carbothermal reduction system 100. Each station of the plurality of stations may be configured to perform a processing step related to carbothermal reduction. A moving platform 140 can continuously process batches without interruption so that the downtime of the system is minimal for removing slag, and recovering carbon.

The moving platform 140 may be configured to suspend reactants mixtures within sections. The moving platform 140 may be divided into a plurality of sections, each section of the plurality of sections configured to suspend a batch of reactants mixture. Each section may include divots, recesses, or cutouts corresponding to locations where the reactants may be deposited. Each section may include two or more locations that are aligned with one other. The divots, recesses, or cutouts store or suspend the reactants mixture that is in the same batch. In some embodiments, the divots, recesses, or cutouts may store or suspend the reactants mixture that is in different batches from one another.

The moving platform 140 may be a rotating disc. The sections of the rotating disc may be pie-shaped. Each pie-shaped section may include a line of divots, recesses, or cutouts that extend radially from the center of the rotating disc. The line of radially extending divots, recesses, or cutouts may correspond to locations where the reactants may be deposited. Each pie-shaped section may include two or more locations that are aligned with one other and radially extend from the center of the rotating disc. In some embodiments, the section may have a line or two or more locations that rotate as the rotating disc is driven.

The moving platform 140 may be a rotating belt. The sections of the rotating belt may be rectangular in nature. Each rectangular section may include a line of divots, recesses, or cutouts corresponding to locations where the reactants may be deposited. Each rectangular section may include two or more locations that are aligned with each other. In some embodiments, the rectangular section may have a line of two or more locations that run in a direction perpendicular to the direction in which the rotating belt is driven. In some embodiments, the moving platform 140 may include a cutout corresponding to a fill station 245 for adding reactants mixture. The fill station 245 may add batches of reactants mixture such that each deposit of reactants mixture in each batch has a leading edge and a trailing edge. Whether the concentrated light source 130 is positioned between the leading edge and the trailing edge may determine the speed at which the rotating platform is driven.

The concentrated light source 130 may be positioned above the moving platform 140 and configured to focus light energy along a line of focus toward the moving platform 140. The concentrated light source 130 may include a plurality of lasers or a plurality of concentrated solar light inlets, such as the first optical inlet 232, the second optical inlet 234, and the third optical inlet 236. The plurality of laser or concentrated solar light inlets may be configured to heat the reactants mixtures suspended on the moving platform 140. The concentrated solar light inlet may channel a solar light source.

The first optical inlet 232, the second optical inlet 234, and the third optical inlet 236 may be configured to focus light energy along a line of focus toward the moving platform 140. For example, the first optical inlet 232 may be a first station and configured to direct a line of light at the first section of the moving platform 140. In another example, the second optical inlet 234 may be at a second station and configured to direct a line of light at a second section of the moving platform 140. In yet another example, the third optical inlet 236 may be a third station and configured to direct a line of light at a third section of the moving platform 140. In some embodiments, each of the concentrated light sources 130 may be oriented towards the center of the moving platform 140, which is a rotating disc. In some configurations, the first optical inlet 232, the second optical inlet 234, and the third optical inlet 236 may be positioned above the rotating disc may be situated 45 degrees from each other. In another configuration, the first optical inlet 232 and the third optical inlet 236 may be positioned above the rotating disc and may be situated at noon and nine o'clock positions, with the second optical inlet 234 situated between the first optical inlet 232 and the third optical inlet 236. In some embodiments, each of the concentrated light sources 130 may be spaced across a rotating belt. Each of the concentrated light sources 130 may be spaced at a station corresponding to a location of the rotating belt. Each of the concentrated light sources 130 may be communicatively coupled to a controller configured to control the intensity of light within the line of focus directed toward the moving platform 140.

In some embodiments, the first optical inlet 232, the second optical inlet 234, and the third optical inlet 236 may all be the same distance from the center or the edge of the moving platform 140. In other embodiments, the first optical inlet 232, the second optical inlet 234, and the third optical inlet 236 may have a different distance or offset from the center or the edge of the moving platform 140. The first optical inlet 232, the second optical inlet 234, and the third optical inlet 236 may be configured to align with at least one of the divots, recesses, or cutouts corresponding to locations for suspending the reactants. The first optical inlet 232, the second optical inlet 234, and the third optical inlet 236 may be configured to perform heating at only a subset of locations with each section of the moving platform 140. For example, a concentrated light source 130 further from the center of the rotating disc may be configured to only perform heating for the outermost location of each section on the rotating disc. In another example, the concentrated light source 130 closest to an edge of a rotating belt may be configured to perform only heating on the locations closest to the edge in each section of the rotating belt.

The slag removal assembly 160 may be situated at a separate station of the carbothermal reduction system 100. The slag removal assembly 160 may include a scooper 262, a grating 264, and a chute 266. The scooper 262 is configured to prevent the slag from passing through the scooper 262. The scooper 262 may have a plurality of blades arranged in a frame where the plurality of blades is configured to allow the unprocessed reactants mixture to pass through the scooper 262. The plurality of blades may be situated sufficiently close to one another such that they are configured to collect slag suspended on the moving platform 140. The frame of the scooper 262 may be configured to rotate upwards to lift the slag off the moving platform 140 and to cause the slag to fall into a grating 264. In some embodiments, any unprocessed reactants mixture that was scooped may fall in the grating back onto the moving platform 140 for further deoxidation processing. The chute 266 may be connected to the grating 264 and has a narrow end furthest from the grating 264. The chute 266 may be configured to be vibrated to allow the reactants mixture gathered by the scooper 262 to vibrate down to the narrow end furthest from the grating 264 to be deposited onto the moving platform 140.

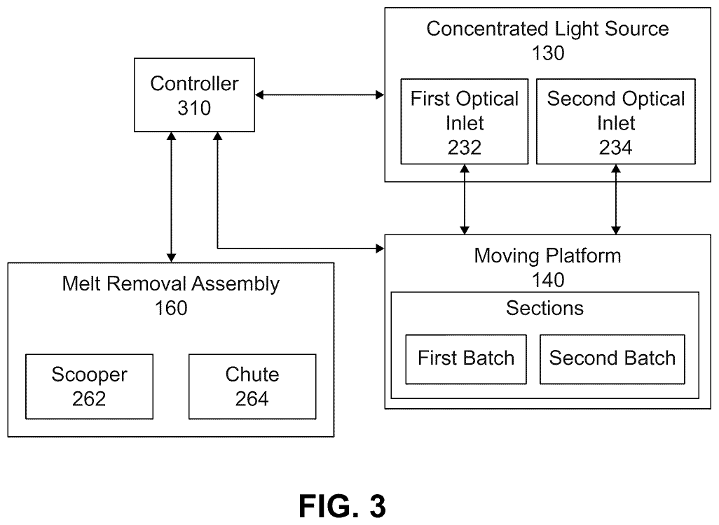

Referring to FIG. 3, illustrated is an example of a block diagram illustrating a controller 310 communicatively coupled to a concentrated light source 130, a moving platform 140, and a slag removal assembly 160 for controlling the uninterrupted reduction of metallic oxides from regolith. The controller 310 may be configured to coordinate the movements of the concentrated light source 130, the moving platform 140, and the slag removal assembly 160 to deoxidize the metal oxides at the maximum rate without interrupting the movement of the moving platform 140. The speeds at which the reactants mixture passes through heating locations and the various stages may maximize system output. For example, the reactants mixture may be a mixture including regolith and adjusting the speeds at which the regolith mixture passes through the heating locations may maximize output of carbon monoxide from the carbothermal reduction system 100. For example, varying the speed of the moving platform 140 allows for the reactants to be converted into slag in chunks. Chunking the slag makes removal from the moving platform 140 much easier using the scooper 262 and the slag removal assembly 260.

The controller 310 may be configured to actuate the concentrated light source 130 to allow light to pass through the concentrated light source 130 to the moving platform 140. The concentrated light source 130 may be configured to focus light energy along a line of focus toward the moving platform 140. The concentrated light source 130 may be a station of the carbothermal reduction system 100 to which the moving platform 140 is configured to move. The concentrated light source 130 may include a first optical inlet 232 and a second optical inlet 234 corresponding to stations of the carbothermal reduction system 100. For example, the first optical inlet 232 may be configured to focus light energy along a first line of focus corresponding to a first section of moving platform 140. In another example, the second optical inlet 234 may be configured to focus light energy along a second line of focus corresponding to a second station of the moving platform 140. The controller 310 may control how long the light energy is focused along the line of energy. The light source may be a laser or a concentrated solar energy. For example, the first optical inlet 232 and the second optical inlet 234 may correspond to lasers or channels configured to pass concentrated solar energy. The concentrated light source 130, the first optical inlet 232 and the second optical inlet 234 may be configured to pass light to the moving platform 140. In some embodiments, the concentrated light source 130 may be on 100% of the time.

The controller 310 may be configured to drive the moving platform 140 through each station of the plurality of stations of the carbothermal reduction system 100. The moving platform 140 may be configured to cycle repeatedly through the plurality of stations without interruption. The moving platform 140 may be configured to suspend the reactants mixture along the lines of focus of the concentrated light source 130. The moving platform 140 may be divided into a plurality of sections where each section is configured to suspend a batch of reactants mixture. The plurality of sections may arrive and depart each of the stations of the carbothermal reduction system 100 at discrete times. For example, a first batch of reactants mixture suspended by a first section may arrive at a first station at a discrete time and a second batch of reactants mixture suspended by a second section may arrive at a second station at the discrete time. In some embodiments, the moving platform 140 is configured to move continuously and without interruption while simultaneously processing multiple batches. For example, the carbothermal reduction system 100 processes the batches continuously as each batch is presented to the stations of the carbothermal reduction system 100. In some embodiments, the moving platform 140 may be a rotating belt or a rotating disc.

The controller 310 may be configured to control the removal of slag from the moving platform 140 using the slag removal assembly 160. The slag removal assembly 160 may include a scooper 262 and a chute 266. The controller 310 may be configured to actuate the frame 1210 holding the plurality of blades of the scooper 262 to lift the slag onto a grating 264 and down a chute 266. The frame 1210 of the scooper 262 may be configured to rotate the plurality of blades 1215 from a horizontal direction to a vertical direction. When the plurality of blades 1215 is in the horizontal direction, the plurality of blades 1215 may collect the slag using the individual blades. When the plurality of blades 1215 is rotated in the vertical direction after collecting the slag, the collected slag may fall on the grating 264 and/or chute 266. In response to detecting slag on the chute 266 and/or grating 264, the controller 310 may be configured to actuate a vibrator to have unprocessed reactants mixture fall through the grating 264 back on to the moving platform 140 for additional processing. Similarly, in response to detecting slag on the chute 266 and/or grating 264, the controller 310 may be configured to actuate a vibrator to have unprocessed reactants mixture to slide down a chute 266 towards the moving platform 140 for additional processing. The vibrator may be attached to the chute 266, the grating 264, or the scooper 262.

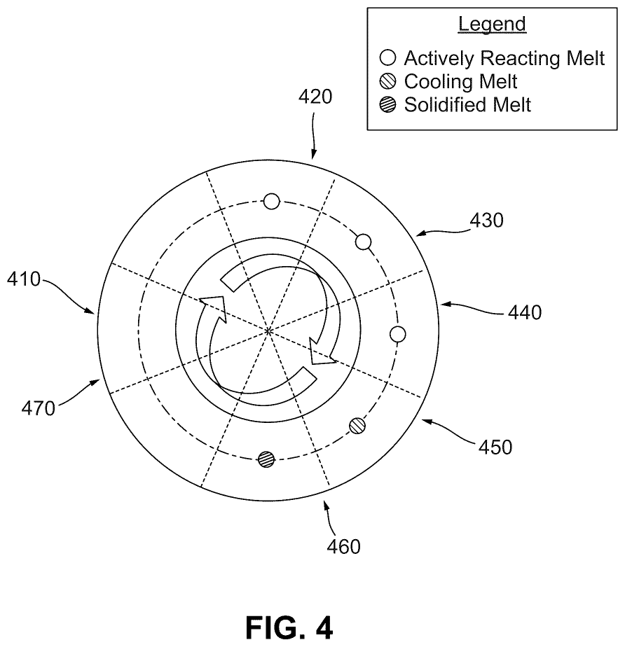

Referring to FIG. 4, illustrated is an example of a moving platform 140 configured to be driven to a plurality of stations of the carbothermal reduction system 100, the plurality of stations configured to perform processing steps for carbothermal reduction. Each section of the moving platform 140 may guide a batch of reactants mixture through its lifetime from freshly mixed regolith to slag. Once the reactants mixture becomes slag, the carbothermal reduction system 100 removes the slag to maintain maximum deoxidation rates of the reactants mixture. The moving platform 140 may be divided into sections that correspond to the stations of the carbothermal reduction system 100. Each section may be configured to suspend a batch of reactants mixture and move each batch to each of the stations of the carbothermal reduction system 100. The plurality of sections may arrive and depart each of the stations of the carbothermal reduction system at discrete times.

In some embodiments, the reactants mixture is added near the beginning station of the plurality of stations. The reactants mixture may pass through a lifecycle from freshly mixed regolith to molten regolith and, lastly, slag by passing through each of the stations. The reactants mixture may undergo a series of heating locations at one or more stations of the carbothermal reduction system 100. Near the end of the plurality of stations, the reactants mixture may transform into slag that requires removal from the moving platform 140. The slag removal station may remove the slag before the moving platform 140 is driven to the beginning cycle or station where freshly mixed reactants mixture is added.

For example, at a first station 410 corresponding to a first section, the reactants mixture may be added to the first section of the moving platform 140. The first section of the moving platform 140 may carry the same reactants mixture to a second station 420 for heating. The second station 420 may be a melt station and may include the first optical inlet 232 configured to focus a light source onto the first section of the moving platform 140. The adding of the reactants mixture at the first station 410 and the first heating at the second station 420 occurs at discrete times for the same batch of reactants mixture. The first section of the moving platform 140 may carry the same reactants mixture to a third station 430 for undergoing a second heating. The third station 430 may be a melt station and may include a second optical inlet 234 configured to focus a light source onto the first section of the moving platform 140. The first heating at the second station 420 and the second heating at the third station 430 occur at discrete times for the same batch of reactants mixture. The first section of the moving platform 140 may carry the same reactants mixture to a fourth station 440 for undergoing a third heating. The fourth station 440 may be a melt station and may include a third optical inlet configured to focus a light source onto the first section of the moving platform 140. The second heating at the third station 430 and the third heating at the fourth station 440 occur at discrete times for the same batch of reactants mixture. Other sections of the moving platform 140 carrying batches are moved through the different stations as the same reactants mixture moves through the first station 410, the second station 420, and the third station 430. The same reactants mixture may grow larger from the first station 410 to the second station 420, from the second station 420 to the third station 430, and from the third station 430 to the fourth station 440.

In some embodiments, the first section of the moving platform 140 may carry the same reactants mixture to a fifth station 450 for undergoing a cooling treatment. The fifth station 450 may be a cooling station and may include a cooling mechanism configured to cool the molten reactants mixture. In some embodiments, the fifth station 450 is a gap between the sixth station 460 and the fourth station 440 to allow the molten reactants mixture to cool. After cooling, the first section of the moving platform 140 may carry the same reactants mixture to a sixth station 460 for slag removal. The sixth station 460 may be a slag removal station and may include a scooper 262 configured to remove the slag from the surface of the moving platform 140. The cooling of the same molten reactants mixture and the removal of slag at the sixth station 460 occurs at discrete times for the same batch of reactants mixture. The seventh station 470 may be first station 410 where reactants mixture is added to the first section of the moving platform 140 and the process repeats with the freshly added reactants mixture and any remaining mixture of the previously processed reactants mixture. Other sections of the moving platform 140 carrying batches are moved through the different stations as the same reactants mixture moves through the first station 410, the second station 420, and the third station 430.

The moving platform 140 may be divided into a plurality of sections where each section may be configured to suspend a batch of reactants mixture. For example, the moving platform 140 may be divided into pie-shaped sections for a rotating disc platform or rectangular portions for a conveyor belt platform. Each section of the moving platform 140 may be driven to each of the plurality of stations. The plurality of sections enables the simultaneous processing of a reactants mixture.

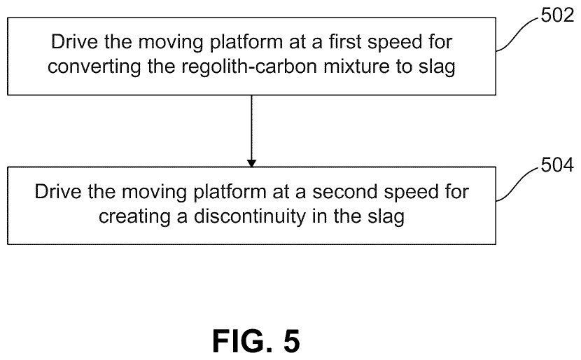

Referring to FIG. 5, illustrated is an example of a flowchart of a method configured to drive the moving platform 140 at a first speed and a second speed to create discontinuities in solidified slag. The moving platform 140 may be configured to move at different speeds causes a discontinuity between a first portion of the slag and a second portion of the slag. The speeds at which the reactants mixture passes through the heating locations and the various stages may maximize system output. For example, the reactants mixture may be a mixture including regolith and adjusting the speeds at which the regolith mixture passes through the heating locations maximizes the carbon monoxide output from the carbothermal reduction system 100. For example, varying the speed of the moving platform 140 allows for the reactants to be converted into slag in chunks. Chunking the slag makes removal from the moving platform 140 much easier using the scooper 262 and the slag removal assembly 260. The reactants mixture may be a reactant or a plurality of reactants.

At 502, the controller 310 may be configured to drive the moving platform 140 at a first speed. The moving platform may be configured to suspend the reactants mixture within the line of focus of the concentrated light source as the moving platform is driven at the first speed. Suspending the reactants mixture within the line of focus of the concentrated light source as the moving platform is driven at the first speed converts the reactants mixture to slag. In some embodiments, the first speed may be nearly 0 cycles or revolutions per minute or 0 cycles or revolutions per minute.

At 504, the controller 310 may be configured to drive the moving platform 140 at a second speed. The moving platform may be configured to suspend the reactants mixture as the moving platform is driven at the second speed. Suspending the reactants mixture as the moving platform is driven at the second speed does not convert the reactants mixture to slag. In some embodiments, the first speed may be slower than a second speed such that the reactants mixture being driven at the second speed causes a discontinuity between a first portion of the slag and a second portion of the slag. The faster speed of the second speed moves the reactants mixture from underneath the concentrated light source and prevents the slag from being solidified into one continuous piece.

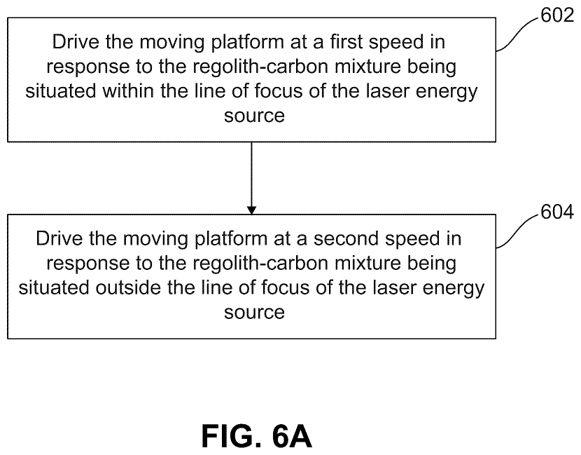

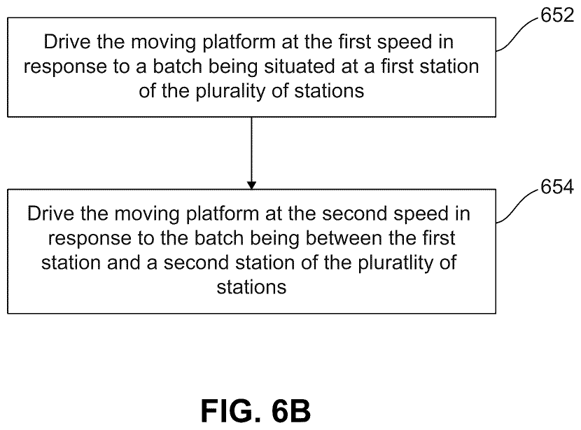

Referring to FIG. 6A, illustrated is an example of a flowchart of a method configured to drive the moving platform 140 at a first speed and a second speed based on whether the reactants mixture is situated within the line of focus of the concentrated light source 130. The moving platform 140 may be configured to suspend the reactants mixture along the lines of focus of the concentrated light source 130. The moving platform 140 may be configured to move at different speeds based on the position of the reactants mixture in relationship to the concentrated light source 130. The speeds at which the reactants mixture passes through the heating locations and the various stages may maximize the performance of the carbothermal reduction system 100. For example, varying the speed of the moving platform 140 allows for the reactants mixture to be converted into slag in chunks. Chunking the slag makes removal from the moving platform 140 much easier using the scooper 262 and the slag removal assembly 260. The reactants mixture may be a reactant or a plurality of reactants.

At 602, the controller 310 may be configured to drive the moving platform 140 at a first speed in response to the reactants mixture being situated within the line of focus of the concentrated light source 130. The controller 310 may be communicatively coupled to a motor or a servo configured to drive the moving platform 140. The controller 310 may be communicatively coupled to a sensor or a servo that determines the position of a section on the moving platform 140. The sensor or the servo may determine when a section carrying the reactants mixture is proximate to the line of focus of the concentrated light source 130. In response to the reactants mixture being proximate to or within the line of focus of the concentrated light source 130, the controller 310 drives the moving platform 140 at a first speed. In some embodiments, the first speed may be slower than a second speed such that the reactants mixture moves more quickly through the line of focus of the concentrated light source 130 than when outside the line of focus of the concentrated light source 130. In some embodiments, the first speed may be nearly 0 cycles or revolutions per minute or 0 cycles or revolutions per minute.

In some embodiments, the fill station 245 may add a continuous amount of regolith mixture to the moving platform 140. In some embodiments, the fill station 245 may add batches of reactants mixture to the moving platform such that each deposit of reactants mixture in each batch has a leading edge and a trailing edge. Whether the concentrated light source 130 is positioned between the leading edge and the trailing edge may determine the speed at which the rotating platform is driven. For example, in response to the line of focus of the concentrated light source 130 being situated between the leading edge and the trailing edge, the controller 310 drives the moving platform 140 at a first speed.

At 604, the controller 310 may be configured to drive the moving platform 140 at a second speed in response to the reactants mixture being situated outside the line of focus of the concentrated light source 130. The sensor or the servo may determine when a section carrying the reactants mixture is outside the line of focus of the concentrated light source 130. In response to the reactants mixture being outside the line of focus of the concentrated light source 130, the controller 310 drives the moving platform 140 at a second speed. In some embodiments, the second speed may be faster than a first speed such that the reactants mixture moves more quickly outside the line of focus of the concentrated light source 130 than when situated within the line of focus of the concentrated light source 130. The time duration of moving platform 140 being outside of the line of focus of the concentrated light source 130 may be shorter than the time duration of the moving platform 140 being within the line of focus of the concentrated light source 130. For example, the time duration within the line of focus may be longer than one minute and the time duration outside the line of focus may be less than one minute.

The fill station 245 may add batches of reactants mixture such that each deposit of reactants mixture in each batch has a leading edge and a trailing edge. Whether the concentrated light source 130 is positioned between the leading edge and the trailing edge may determine the speed at which the rotating platform is driven. For example, in response to the line of focus of the concentrated light source 130 being situated outside the leading edge and the trailing edge, the controller 310 drives the moving platform 140 at a second speed. In some embodiments, the fill station 245 may add a continuous amount of reactants mixture to the moving platform 140. The continuous amount of reactants mixture may increase the up-time time of the carbothermal reduction system 100 and decrease the precision needed to coordinate the batches with the on-time of the concentrated light source 130.

Referring to FIG. 6B, illustrated is an example of a flowchart of a method configured to drive the moving platform 140 at a first speed and a second speed based on whether a batch of reactants mixture is situated at a first station of the plurality of stations or situated between the first and a second station of the plurality of stations. The moving platform 140 may be configured to suspend a batch of reactants mixture at the various stations of the carbothermal reduction system 100. The moving platform 140 may be configured to move at different speeds based on the position of the batch of reactants mixture in relationship to the stations of the carbothermal reduction system 100. The speeds at which the reactants mixture passes through the plurality of stations may maximize the output of the carbothermal reduction system 100. For example, varying the speed of the moving platform 140 allows for the reactant material to be converted into slag in chunks. Chunking the slag makes removal from the moving platform 140 much easier using the scooper 262 and the slag removal assembly 260. The reactants mixture may be a reactant or a plurality of reactants.

At 652, the controller 310 may be configured to drive the moving platform 140 at a first speed in response to a batch of reactants mixture being situated at a first station of the plurality of stations of the carbothermal reduction system 100. The controller 310 may be communicatively coupled to a motor or a servo configured to drive the moving platform 140. The controller 310 may be communicatively coupled to a sensor or a servo that determines the position of a section on the moving platform 140. The sensor or the servo may determine when a section carrying the batch of reactants mixture is proximate to the first station of the carbothermal reduction system 100. In response to the batch of reactants mixture being proximate to or at the first station of the carbothermal reduction system 100, the controller 310 drives the moving platform 140 at a first speed. In some embodiments, the first speed may be slower than a second speed such that the batch of reactants mixture moves more slowly at the first station than when between the first station and the second station. In some embodiments, the first speed may be nearly 0 stations per minute or 0 stations per minute.

At 654, the controller 310 may be configured to drive the moving platform 140 at a second speed in response to the batch of reactants mixture being situated between the first station and the second station. The sensor or the servo may determine when a section carrying the batch of reactants mixture is between the first station and the second station. In response to the batch of reactants mixture being between the first station and the second station, the controller 310 drives the moving platform 140 at a second speed. In some embodiments, the second speed may be faster than a first speed such that the batch of reactants mixture moves more quickly between the first station and the second station than when situated at the first station. The time duration of moving platform 140 being between the first station and the second station may be shorter than the time duration of the moving platform 140 being within the line of focus of the concentrated light source 130. For example, the time duration at the first station may be longer than one minute, and the time duration between the first station and the second station may be less than one minute.

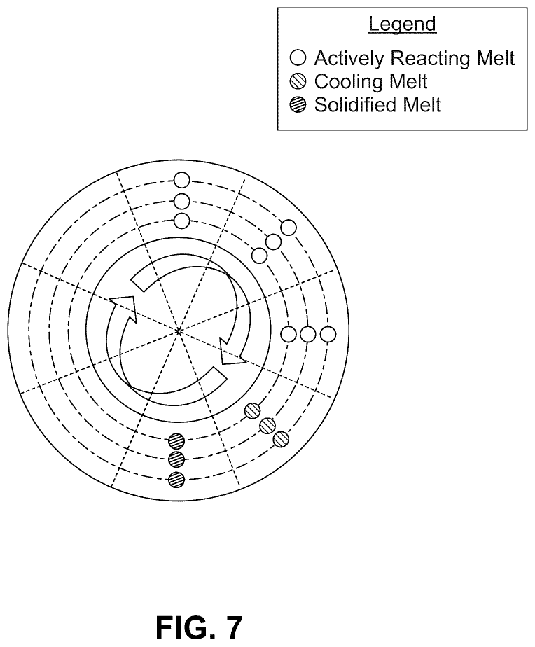

Referring to FIG. 7, illustrated is an example of a moving platform 140 divided into a plurality of sections, the sections configured to suspend a batch of reactants mixture. The sections holding batches may be continually introducing unprocessed reactants mixture to the stations of the carbothermal reduction system. In other words, processed regolith may leave a station and new incoming unprocessed regolith may arrive at a station.

In some embodiments, the batch of reactants mixture is in the same melt stage. The melt stages may include an actively reacting stage, a cooling stage, and a solidified stage (i.e., slag). The batch of reactants mixtures may include locations holding the reactants mixture within the same section of the plurality of sections on the moving platform 140. Each location within the same section may have a different offset from the center of the moving platform 140 or an edge of the moving platform 140. Each location holding in the section of the plurality of sections may suspend the same batch of reactants mixtures. The locations within the same section can hold the reactants mixtures from the same batch of reactants mixtures. The concentrated light source 130 may be configured to perform the same heating for all locations of the same batch of reactants mixture.

In some embodiments, the moving platform 140 may have two or more sets of melt locations within a section of the moving platform 140 that arrives at a station of the carbothermal system. Each melt location of the two or more sets of melt locations may be arranged in the same section arriving at the same station. Each melt location of the two or more sets of melt locations may be in the same melt stage where the melt stage can be an actively reacting stage, a cooling stage, and a solidified stage. The concentrated light source 130 may be configured to perform the same heating for all melt locations within a section of the moving platform 140.

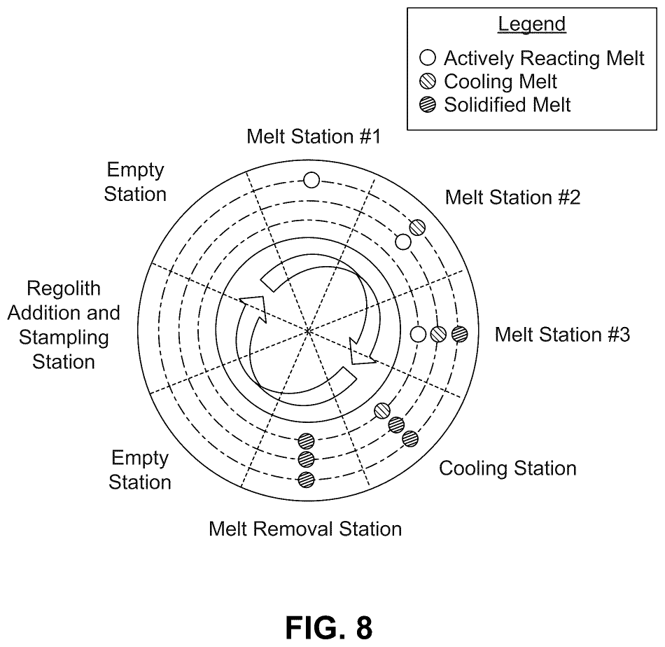

Referring to FIG. 8, illustrated is an example of a moving platform 140 divided into a plurality of sections, the sections configured to suspend two or more batches of reactants mixture, where the two or more batches of reactants mixture are in a different melt stage. The sections holding batches may be continually introducing unprocessed reactants mixture to the stations of the carbothermal reduction system. In other words, processed regolith may leave a station and new incoming unprocessed regolith may arrive at a station.

In some embodiments, two or more batches of reactants mixture in the same section may be in different melt stages. The melt stages may include an actively reacting stage, a cooling stage, and a solidified stage (i.e., slag). The two or more batches of reactants mixtures may occupy locations within the same section of the plurality of sections on the moving platform 140. Each location within the same section may have a different offset from the center of the moving platform 140 or an edge of the moving platform 140. The locations within the same section can hold the reactants mixture from different batches of reactants mixtures. Each location holding in the section of the plurality of sections may suspend different batches of reactants mixtures. Each of the reactants mixtures at each of the locations in the section of the plurality of sections may be in different melt stages at a discrete time. The concentrated light source 130 may be configured to perform the same heating for the two or more batches of reactants mixture.

In some embodiments, the moving platform 140 may have two or more sets of melt locations within a section of the moving platform 140 that arrives at a station of the carbothermal system. Each melt location of the two or more sets of melt locations may be arranged in the same section arriving at the same station. Each melt location of the two or more sets of melt locations may be in a different melt stage where the melt stage can be an actively reacting stage, a cooling stage, and a solidified stage. The concentrated light source 130 may be configured to perform the same heating for all melt locations for all different batches within a section of the moving platform 140.

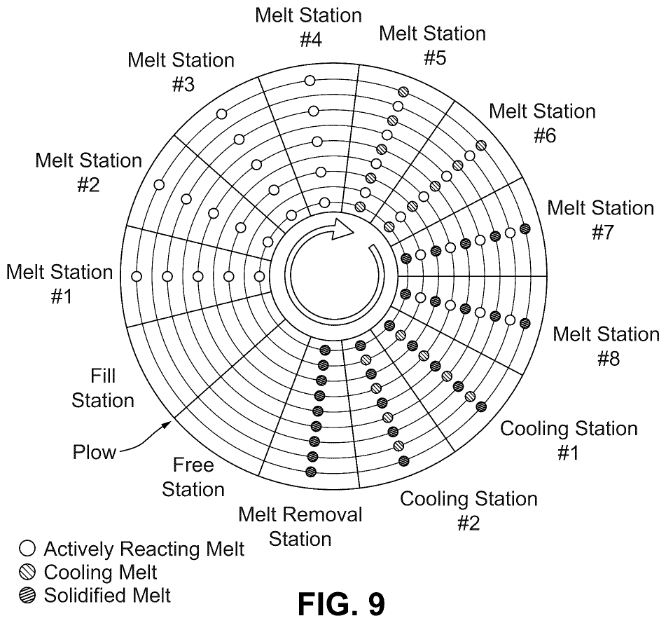

Referring to FIG. 9, illustrated is an example of a moving platform 140 divided into a plurality of sections, the sections configured to suspend two or more batches of reactants mixture, where the two or more batches of reactants mixture form an alternating pattern of reactants mixtures having a different melt stage or melt processing time. A batch of the two or more batches may alternate with another batch of the two or more batches across the section of the moving platform 140. For example, a location within a section may hold a first batch of reactant material and a second location adjacent to the first location may hold a second batch of reactant material.

The two or more batches of reactants mixtures may occupy alternating locations within the same section of the plurality of sections on the moving platform 140. Each location within the same section may have a different offset from the center of the moving platform 140 or an edge of the moving platform 140. The locations within the same section can hold the reactants mixture from two or more batches of reactants mixtures. Each location holding in the section of the plurality of sections may suspend two or more batches of reactants mixtures. Each of the reactants mixtures at each of the locations in the section of the plurality of sections may be in two or more melt stages at a discrete time. The melt stages may include an actively reacting stage, a cooling stage, and a solidified stage (i.e., slag).

The concentrated light source 130 may be configured to perform a different heating for each of the two or more batches of reactants mixture. For example, a first batch at alternating locations in a first section may undergo a heating and a second batch at the other alternating locations in the first section may undergo a cooling treatment. In another example, a third batch at alternating locations in a second section may undergo a cooling treatment while the slag in the fourth batch at the other alternating locations sits idle or is removed at the slag removal station.

The concentrated light source 130 may be configured to perform a different heating for each batch within a section of the moving platform 140. In some embodiments, the concentrated light source 130 may include a first optical inlet 232 and a second optical inlet 234 where the first optical inlet 232 is aligned with at least one of a first set of alternating locations and the second optical inlet 234 is aligned with a second set of alternating locations. Similarly, the regolith adding station and the cooling station may be configured to perform a different addition/cooling for each batch within a section of the moving platform 140.

In some embodiments, the moving platform 140 may have two or more sets of melt locations within a section of the moving platform 140 that arrives at a station of the carbothermal system. Each melt location of the two or more sets of melt locations in the same section arriving at the same station may be in a different melt stage. Each melt location of the two or more sets of melt locations may be in a different melt stage where the melt stage can be an actively reacting stage, a cooling stage, and a solidified stage.

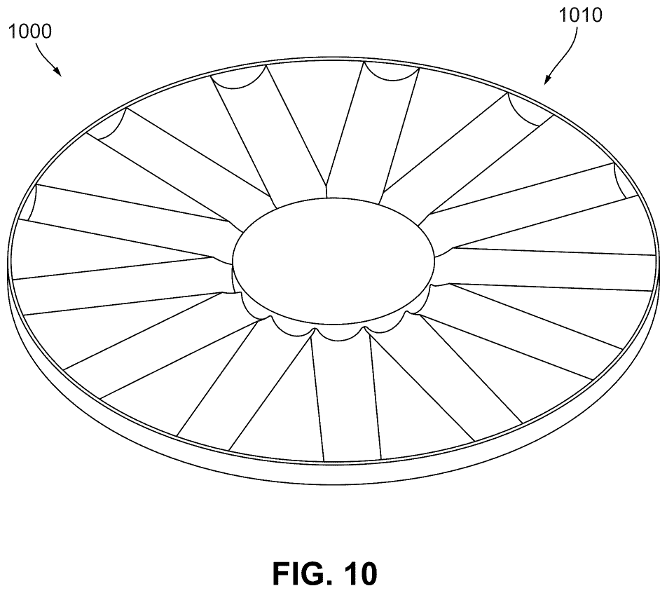

Referring to FIG. 10, illustrated is an example of a trough moving platform 1000 divided into sections, each section of the plurality of sections having a trough 1010 for suspending one or more batches. The moving platform 140 may be a rotating disc. The troughs 1010 may correspond to the sections of the moving platform 140 where each trough 1010 has a first end coupled to an outer edge of the rotating disc and a second end coupled to a center of the rotating disc. The second end of each trough 1010 may have an opening configured to receive the slag of solidified reactants mixture. In some embodiments, the controller 310 drives the moving platform 140 at the first speed when the trough 1010 is positioned at a first station. The controller 310 may drive the moving platform 140 at a second speed when the trough 1010 is positioned between the first station and the second station of the carbothermal reduction system 100. Each trough 1010 may correspond to the locations within the same section that carries the reactants mixture.

In some embodiments, each trough may include divots, recesses, or cutouts corresponding to locations where the reactant material may be deposited. Each section may include two or more locations that are aligned with one other. The divots, recesses, or cutouts store or suspend the reactants mixture that is in the same batch. In some embodiments, the divots, recesses, or cutouts may store or suspend the reactants mixture that is in different batches from one another.

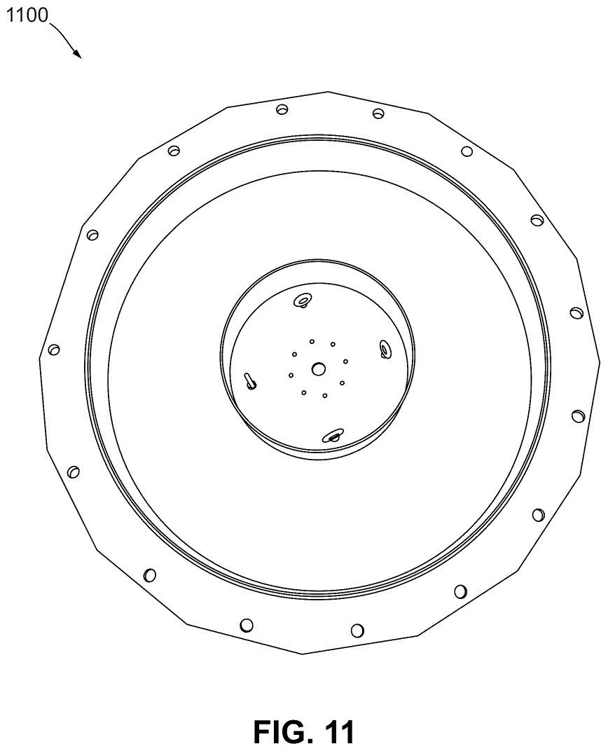

Referring to FIG. 11, illustrated is an example of a recessed moving platform 1100.

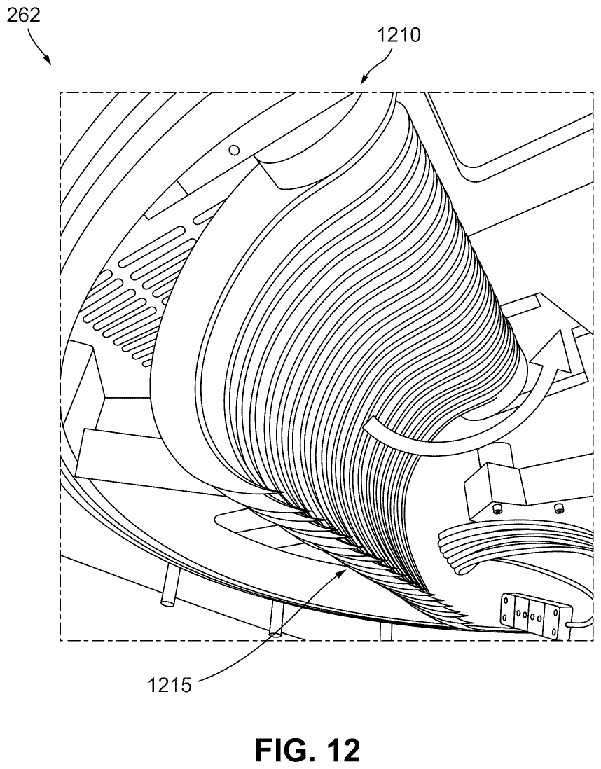

Referring to FIG. 12, illustrated is an example of a scooper 262 having a plurality of blades 1215 arranged in a frame 1210 where the plurality of blades 1215 are configured to collect slag on the moving platform 140 and to prevent the slag from passing through the scooper 262. The scooper 262 may be configured to prevent the slag from passing through the scooper 262 to the regolith filling station. The scooper 262 may have a plurality of blades 1215 arranged in a frame 1210 where the plurality of blades 1215 is configured to allow the unprocessed reactants mixture to pass through the scooper 262. The frame 1210 of the scooper 262 may be configured to rotate the plurality of blades 1215 from a horizontal direction to a vertical direction. When the plurality of blades 1215 is in the horizontal direction, the plurality of blades 1215 may collect the slag using the individual blades. The plurality of blades 1215 is situated sufficiently close to one another such that they are configured to collect slag suspended on the moving platform 140. The frame 1210 of the scooper 262 may be configured to rotate upwards to lift the slag off the moving platform 140 and to cause the slag to fall into a grating 264. In some embodiments, any unprocessed reactants mixture that was scooped may fall in the grating back onto the moving platform 140 for further deoxidation processing. The plurality of blades 1215 may also rake the unprocessed reactants mixture.

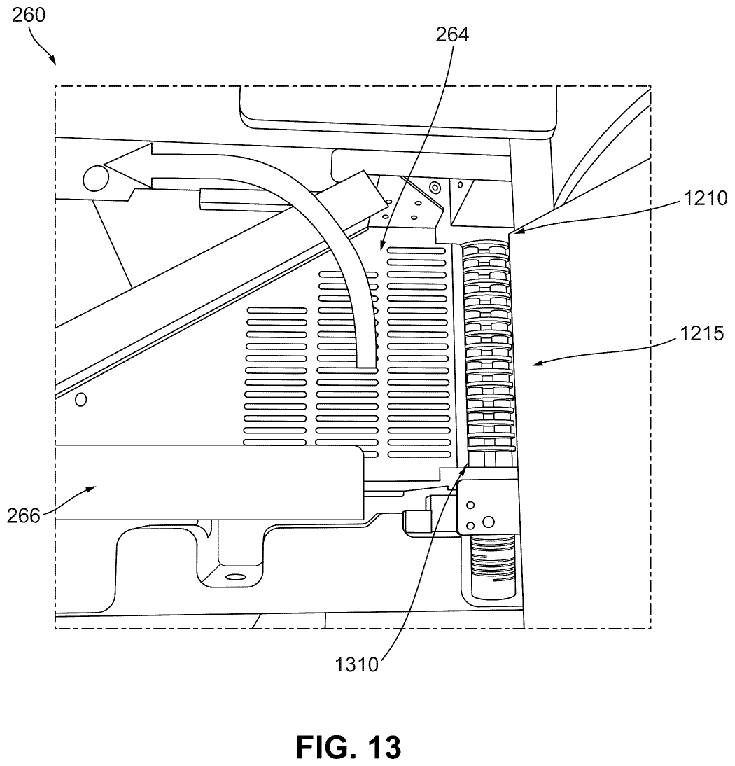

Referring to FIG. 13, illustrated is an example of a chute 266 connected to the grating 264, the chute 266 having a narrow end furthest from the grating 264 and the chute 266 being configured to be vibrated to allow any reactants mixture gathered by the scooper 262 to vibrate down to the narrow end furthest from to grating 264 to be deposited onto the moving platform 140. The plurality of blades 1215 is situated sufficiently close to one another such that they are configured to collect slag suspended on the moving platform 140. The frame 1210 of the scooper 262 may be configured to rotate upwards to lift the slag off the moving platform 140 and to cause the slag to fall onto a grating 264. In some embodiments, any unprocessed reactants mixture that was scooped may fall in the grating back onto the moving platform 140 for further deoxidation processing. When the plurality of blades 1215 is rotated in the vertical direction after collecting the slag, the collected slag may fall on the grating 264 and/or chute 266. In response to detecting slag on the chute 266 and/or grating 264, the controller 310 may be configured to actuate a vibrator to have unprocessed reactants mixture fall through the grating 264 back onto the moving platform 140 for additional processing. Similarly, in response to detecting slag on the chute 266 and/or grating 264, the controller 310 may be configured to actuate a vibrator to have the unprocessed reactants mixture to slide down a chute 266 towards the moving platform 140 for additional processing. The vibrator may be attached to the chute 266, the grating 264, or the scooper 262.

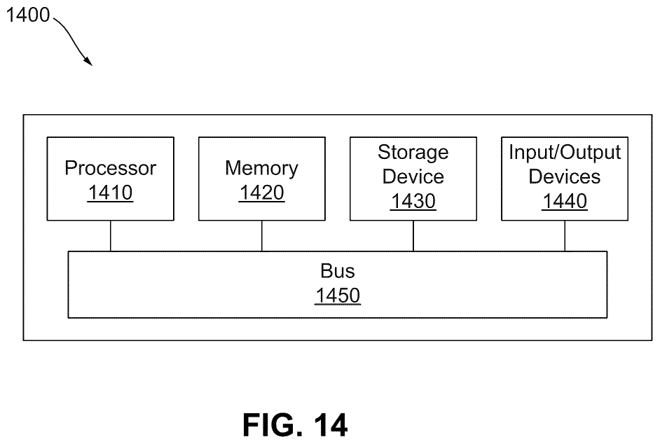

Referring to FIG. 14, the computing system 1400 may include a processor 1410, a memory 1420, a storage device 1430, and an input/output device 1440. The processor 1410, the memory 1420, the storage device 1430, and the input/output device 1440 may be interconnected via a system bus 1450. The processor 1410 is capable of processing instructions for execution within the computing system 1400. Such executed instructions may implement one or more components of, for example, a continuous production system for carbothermal reduction. In some exemplary embodiments, the processor 1410 may be a single-threaded processor. Alternately, the processor 1410 may be a multi-threaded processor. The processor 1410 is capable of processing instructions stored in the memory 1420 and/or on the storage device 1430 to display graphical information for a user interface provided via the input/output device 1440.

The memory 1420 is a non-transitory computer-readable medium that stores information within the computing system 1400. The memory 1420 may be configured to store data structures representing configuration object databases, for example. The storage device 1430 is capable of providing persistent storage for the computing system 1400. The storage device 1430 may be a floppy disk device, a hard disk device, an optical disk device, or a tape device, or other suitable persistent storage means. The input/output device 1440 provides input/output operations for the computing system 1400. In some exemplary embodiments, the input/output device 1440 includes a keyboard and/or pointing device. In various implementations, the input/output device 1440 includes a display unit for displaying graphical user interfaces.

According to some exemplary embodiments, the input/output device 1440 may provide input/output operations for a network device. For example, the input/output device 1440 may include Ethernet ports or other networking ports to communicate with one or more wired and/or wireless networks (e.g., a local area network (LAN), a wide area network (WAN), the Internet, a public land mobile network (PLMN), and/or the like).

In some exemplary embodiments, the computing system 1400 may be used to execute various interactive computer software applications that may be used for organization, analysis, and/or storage of data in various formats. Alternatively, the computing system 1400 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 1440. The user interface may be generated and presented to a user by the computing system 1400 (e.g., on a computer screen monitor, etc.).

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or clement is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

While the foregoing is directed to implementations of the present disclosure, other and further implementations of the disclosure may be devised without departing from the basic scope thereof, and the scope thereof is determined by the claims that follow.

What is claimed is:

1. A system comprising:
a concentrated light source configured to focus light energy along a line of focus;
a moving platform configured to face the concentrated light source, the moving platform configured to suspend a reactants mixture during movement of the moving platform; and
a controller coupled to the concentrated light source and the moving platform, the controller configured to:
drive the moving platform at a first speed for converting the reactants mixture to slag, the moving platform configured to suspend the reactants mixture within the line of focus of the concentrated light source as the moving platform is driven at the first speed; and
drive the moving platform at a second speed for creating discontinuity in the slag, the moving platform configured to suspend the reactants mixture as the moving platform is driven at the second speed.

2. The system of claim 1, wherein suspending the reactants mixture within the line of focus of the concentrated light source as the moving platform is driven at the first speed converts the reactants mixture to the slag, wherein suspending the reactants mixture as the moving platform is driven at the second speed does not convert the reactants mixture to the slag.

3. The system of claim 1, wherein the moving platform is configured to repeatedly cycle through a plurality of stations, each station of the plurality of stations configured to perform a processing step related to carbothermal reduction, and wherein the controller is further configured to:
drive the moving platform through each station of the plurality of stations.

4. The system of claim 3, wherein the moving platform is divided into a plurality of sections, each section of the plurality of sections configured to suspend a batch of reactants mixtures, and wherein the controller is further configured to:
drive each section of the moving platform to each of the plurality of stations configured to perform the processing step related to carbothermal reduction at discrete times.

5. The system of claim 4, wherein the controller is further configured to:
drive the moving platform at the first speed in response to the batch being situated at a first station of the plurality of stations; and
drive the moving platform at the second speed in response to the batch being between the first station and a second station of the plurality of stations.

6. The system of claim 4, wherein the concentrated light source includes a plurality of lasers, wherein each of the plurality of lasers corresponds to a station of the plurality of stations, and wherein each of the plurality of lasers is configured to heat the batch of reactants mixtures suspended by a section of the plurality of sections of the moving platform.

7. The system of claim 6, wherein the batch of reactants mixtures includes locations holding the reactants mixture in a section of the plurality of sections, each location of the locations having a different offset from at least one of a center of the moving platform or an edge of the moving platform.

8. The system of claim 7, wherein the locations holding the batch of reactants mixtures in the section of the plurality of sections are in the same melt stage at a discrete time, the melt stage being one of an actively reacting stage, a cooling stage, and a solidified stage.

9. The system of claim 7, wherein at least two locations holding the batch of reactants mixtures in the section of the plurality of sections are in different melt stages at a discrete time, the melt stage being one of an actively reacting stage, a cooling stage, and a solidified stage.

10. The system of claim 1, wherein the system further comprises:
a scooper having a plurality of blades arranged in a frame, the plurality of blades configured to allow the reactants mixture to pass through the scooper, the plurality of blades configured to collect the slag suspended on the moving platform and to prevent the slag from passing through the scooper.

11. The system of claim 10, wherein the frame of the scooper is configured to rotate to lift the slag off the moving platform and to cause the slag to fall into a grating.

12. The system of claim 11, further comprising:
a chute connected to the grating, the chute having a narrow end furthest from the grating, the chute configured to be vibrated to allow the reactants mixture gathered by the scooper to vibrate down to the narrow end furthest from the grating to be deposited onto the moving platform.

13. The system of claim 1, wherein the reactants mixture being driven at the second speed causes a discontinuity between a first portion of the slag and a second portion of the slag, wherein the first speed is slower than the second speed, and wherein the moving platform is at least one of a rotating belt or a rotating disc.

14. A system comprising:
at least one processor; and
at least one non-transitory storage media storing instructions that, when executed by the at least one processor, cause the at least one processor to perform operations configured to:
driving a moving platform at a first speed for converting a reactants mixture to slag, the moving platform configured to suspend the reactants mixture within a line of focus of a concentrated light source as the moving platform is driven at the first speed, the moving platform configured to face the concentrated light source, the moving platform configured to suspend the reactants mixture during movement of the moving platform, the concentrated light source configured to focus laser energy along the line of focus; and
driving the moving platform at a second speed for creating a discontinuity in the slag, the moving platform configured to suspend the reactants mixture as the moving platform is driven at the second speed.

15. The system of claim 14, further comprising:
driving the moving platform through each station of a plurality of stations, the moving platform is configured to repeatedly cycle through the plurality of stations, and wherein each station of the plurality of stations is configured to perform a step related to carbothermal reduction.

16. The system of claim 15, further comprising:
driving each section of a plurality of sections of the moving platform to each of the plurality of stations configured to perform the step related to carbothermal reduction at discrete times, wherein the moving platform is divided into the plurality of sections, and wherein each section of the plurality of sections configured to suspend a batch of reactants mixtures.

17. The system of claim 16, further comprising:
drive the moving platform at the first speed in response to the batch being situated at a first station of the plurality of stations; and
drive the moving platform at the second speed in response to the batch being between the first station and a second station of the plurality of stations.

18. The system of claim 14, wherein suspending the reactants mixture within the line of focus of the concentrated light source as the moving platform is driven at the first speed converts the reactants mixture to the slag, wherein suspending the reactants mixture as the moving platform is driven at the second speed does not convert the reactants mixture to the slag.

19. The system of claim 14, wherein the reactants mixture being driven at the second speed causes a discontinuity between a first portion of the slag and a second portion of the slag, wherein the first speed is slower than the second speed, and wherein the moving platform is at least one of a rotating belt or a rotating disc.

20. A system comprising:
at least one processor; and
at least one non-transitory storage media storing instructions that, when executed by the at least one processor, cause the at least one processor to perform operations configured to:
drive a moving platform configured to suspend a reactants mixture at a first speed in response to the reactants mixture being situated within a line of focus of a concentrated light source, the moving platform configured to face the concentrated light source, the moving platform configured to suspend the reactants mixture during movement of the moving platform, the concentrated light source configured to focus laser energy along the line of focus; and
drive the moving platform configured to suspend the reactants mixture at a second speed in response to the reactants mixture being situated outside the line of focus of the concentrated light source.
